(19) United States
(12) Patent Application Publication
(10) Pub. No.: US 2012/0327634 A1
(43) Pub. Date: Dec. 27, 2012

(54) Light source patterns that illuminate from custom made blankets unto the bedroom ceilings for infants and children's bedrooms and bedroom ceilings

(76) Inventor: Monica Aranda, Arleta, CA (US)

(21) Appl. No.: 13/134,975

(22) Filed: Jun. 21, 2011

(51) Int. Cl. F21V 21/08

(52) U.S. Cl. 362/103

(57) ABSTRACT

The Invention provides a blanket/bed spread/baby blanket/infant cover/and or any type Of (blanket like cover) bed spread with a sense of stability & comfort having light illuminations reflect from them to the ceiling(s). I/WE believe that children/infants and young adults having a blanket with light/illumination/and or light source pattern(s) displaying on them and on the ceiling(s) will not only help the parents get their children to bed, but will also make the user, (the children) feel safe and secure at (bed time) night time. This idea/invention/utility license is safe, comforting and will give a sense of security and will meet all (UL) listed & (UL) listings as well as all state and government codes and regulations for safety and for the end user.

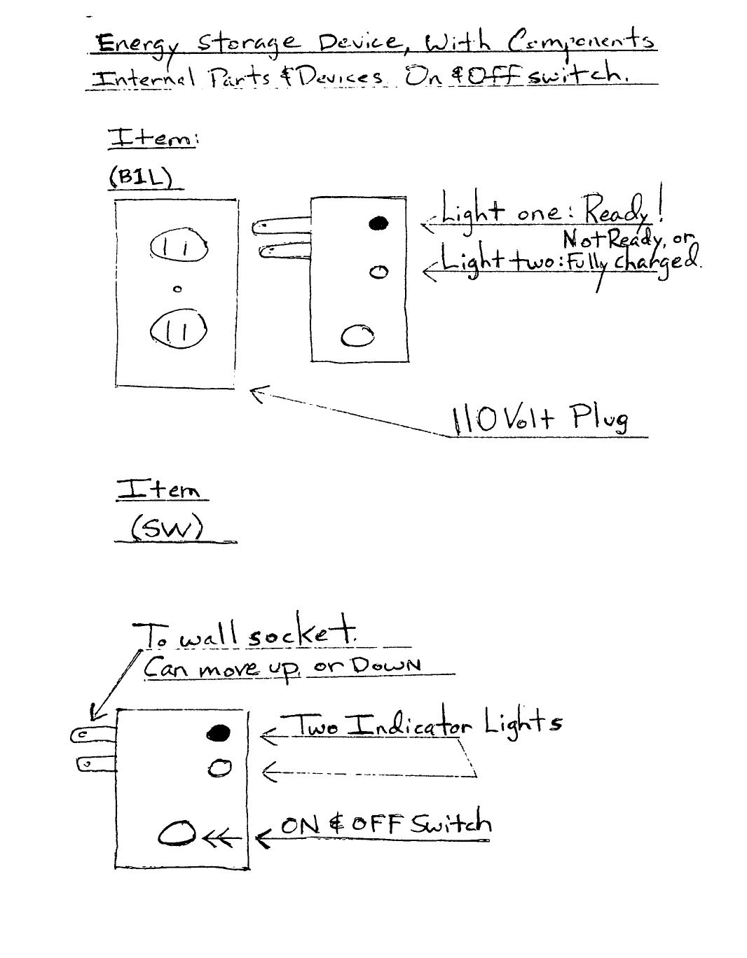

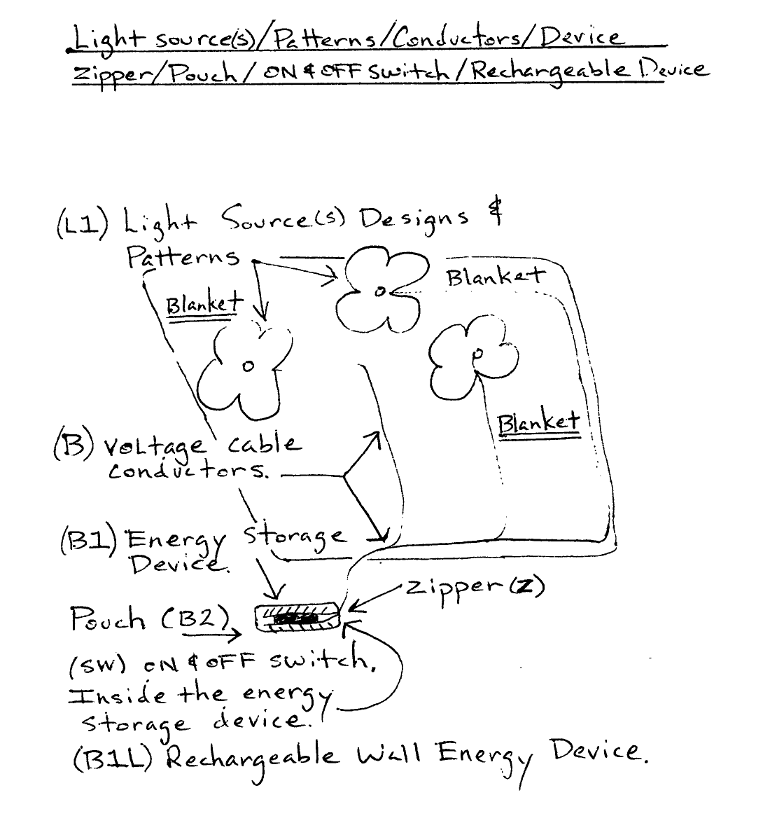

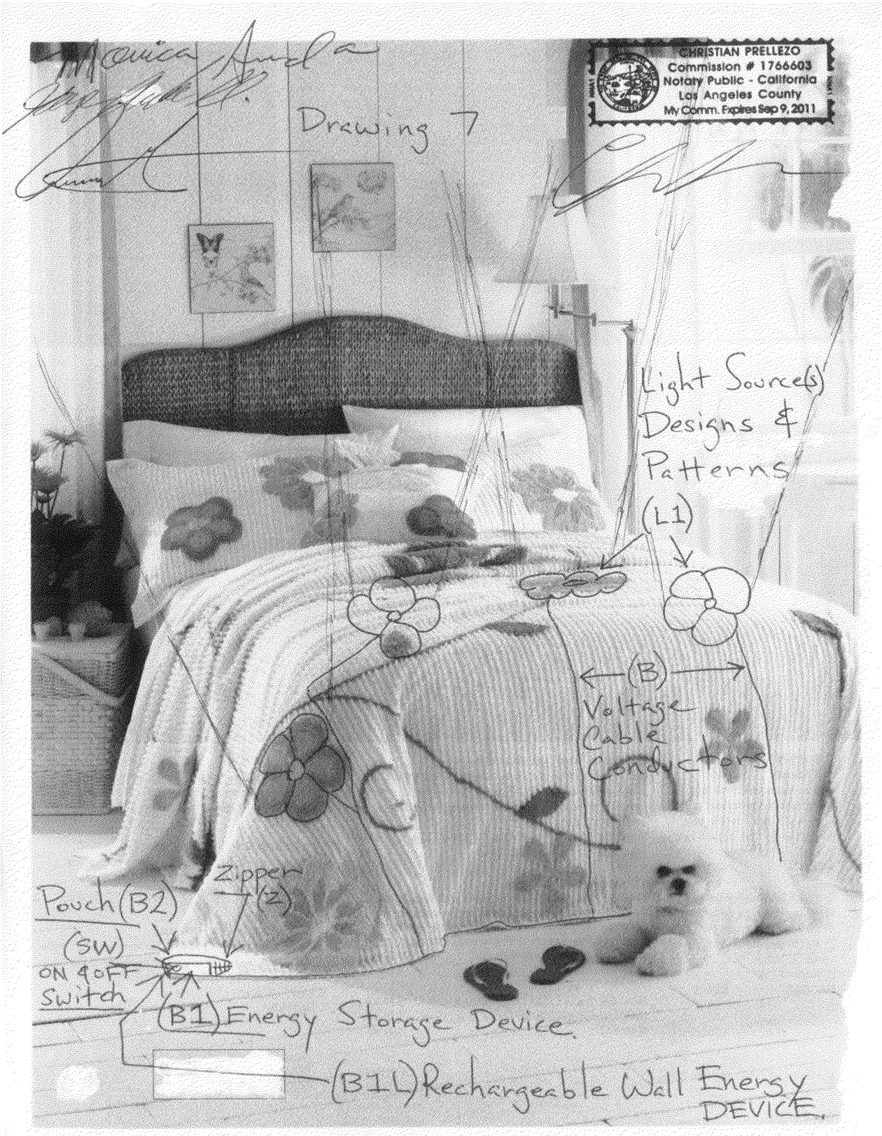

The present invention relates light source patterns that illuminate from custom Made blankets onto the bedroom ceilings for infants and children's rooms. These will be Preferably but not limited to light-emitting diodes (LED) displays with different colored illuminations that will be working as a comfort light and is powered by a rechargeable energy Storage device that's plugs into the blanket(s).

The device is comprised of the following elements:
The blankets will have conductors/wires in them providing power/current-see Drawing (B) to the light sources (L1) preferably, but not limited to 1-24 Volts-DC From a (preferably) energy storage device—See (B1). The device (B1) will be Stored/connected inside a (Kangaroo like) pouch. See (B2) that has a preferably Zipper like compartment, but not limited to this, See (Z). The rechargeable wall Energy storage device will (preferably) have one or two indicator light/lights Displaying if the charge is low-or fully charged see (B1L) by two separate light Displays, or an indicator light with the option to view if the energy storage Device is ready for use or has a low-charge. The light source(s) illuminating Emitters/devices preferably light-emitting diodes (LED) displays will produce Visual illumination(s) with (preferably) different colors when voltage is applied To it. A on and off button or switch will be included as well in order to provide Or disconnect current/power going to light source or sources, See (SW). The Energy storage device or rechargeable energy storage device may consist of all And any materials/parts related or known in the field, including: a battery or cell (power/voltage) consisting of lithium, ion, nickel-cadmium, nickel metal hydride, icad, deep cycle, and any materials related to this known field. The parts and electric or electronic devices related to this field can be used such as: Diodes, resistors, push buttons, on or off devises and or switches, solder, transistors, copper, aluminum, and or copper clad-aluminum wire, light sources, devices or parts that cause or can create illumination(s), software and or any chips or computer devices that can or may create traces and or memory, electric and or electronic effects (light source effects) or illumination(s) from a source to create images. All devices may be installed inside the blanket(s) on top, between two or more layers or layered, sewn on, in, or in between the blankets or fabric(s) or materials in order to create a finished product that will create light source patterns and or images on top of the blankets or image(s) that will display onto the ceilings (projected light) of the rooms, or any type of bedroom(s).

The on & off button is naturally in an off (or open) state, in which current is not Flowing through the circuit(s). When a user closes the switch (on) in the parallel switch section (SW) the circuit(s) will be closed and current/voltage electricity will flow from the energy Storage device (B1), through the voltage cable conductor(s) (B), causing light to be emitted From the (L1) design(s) and or pattern(s). If the circuit is opened (off) and the current/voltage Electricity stops flowing to the design(s) and or pattern(s) then the (L1) design(s) and or pattern(s) will turn off. Elements needed: A Wall charger with a (preferably) rechargeable (DC) Voltage,energy storage device but not limited to this(B1 & B1L), Cable(s) or conductors with the proper (DC) voltage/current electricity for the light source(s) to illuminate. A zipper (Z) with a Kangaroo-like pouch or (pocket) storage holding compartment for the energy storage device. Light-illumination(s) design(s) and or pattern(s) (L1). A on & off switch/button or device (SW) The light sources (preferably) light-emitting diodes (LED) but not limited to this. A blanket, bed Cover or one similar to this. All devices known in the field of electricity and electronics in order To properly operate device/controls to properly activate and de-activate operation of parts and Devices for the finish intended use of this invention/patent/Utility license.

The wiring diagram shown on the drawing is powered by an energy storage device (B1) This device provides proper voltage to light emitter(s) and or light sources that will display the Same color or several different colored light pattern(s) (L1) onto a bedroom ceiling. A on & off Button is needed to control displays. A storage (device) is needed to (contain) hold in place Both the energy storage device & the connection/adapter to “plug-in” the device in order to Operate the invention for its intended use.

The Home charger is plugged into a standard 110 Volt receptacle/outlet with the Energy storage device built-in the charger, or the charger itself detaches/disconnects from the Energy storage device (B1). After the battery (energy storage device) is fully charged, the home Charger or device itself will indicate that is has been completely charged and is ready for use for The consumer. The (preferably) green light that turns on will notify the end user that it's “OK” To now remove the battery (energy storage device) and un-zip, or open the blankets location Where the compartment is in order to connect, or plug in the blankets female to male adapter. Once you plug-in the battery (energy storage device) you can now push the (Device) on & off Button in order to see the design/patterns that have “light sources” on/in them displaying (reflecting) it's image/images onto the ceiling above the infants, children, kids, and even adults Rooms and bedrooms ceilings working as a light or comfort light source. This invention/patent may also provide different bed sheets/coverings/pillow cases and pillows to match the blankets with the option to display or not display light sources.

To make the invention: Provide a blanket that has a layer on top with a light pattern Already designed and or pre-fabricated with light sources in or on them. Provide the same Layer put it under the blanket two provide two different layers of blankets and have the light Sources and or all of the other devices and parts in the middle of the two blankets (layers) Or any combination of the three mixed together in order to create a light source and or image Pattern(s) to display (light-up) or to have it display onto the bedroom ceiling above the bed it is on or next to for its intended use.

Provide/design/invent a device that has a (All-in-one)component electronic device with all the diodes, relays, resistors, electronic elements, capacitors, transformers, safety devices, computer and software parts/pieces and elements known in the electronic and electrical field And or industry in order to design, fabricate and complete a device/part/component that is (UL Listed) approved by the United States Government and USPTO office rules and regulations In order to complete a “finished operable, approved” device to display the light-illuminations In the field or any new inventions that may provide a “Light source” or light illumination(s) that Will display light sources for this invention from a electronic/electric device that plugs into a wall socket and other parts/elements/devices that are on the blanket and also that has the Capability to charge and recharge and that has the capability (option) to turn on & off.

This electronic/electric device will provide the proper current/voltage electricity for the Final working product and will have Illumination(s) of the light sources that will be on or in the blankets. The light sources will also be the right wattage/current and correct amount of light sources with a balanced load to illuminate enough visual light from the blanket(s) and also from the blanket(s) to the ceiling above the blanket(s) for its intended projected visual use.

The blankets will have wires (preferably flat) in or on them going from the energy storage device location on the blanket(s) to the light design or pattern(s). Connections of the Conductors will be needed from the (battery) energy storage device, location to the center or light designs/pattern(s). A design or pattern will be sown on or into the blanket(s) in many areas and locations on the blanket(s). A cover/plastic/protector or something similar will be needed to (protect) the cover and the light-source(s) on or in the blanket(s).

All materials will comprise of a type that is flexible/bendable so the blanket(s) may be able to move around and will not break parts easily. The light-sources will also be of a material that will not create “heat” due to the type of Light-emitting diodes (LED) or other light source(s) that are made for “bright light output with low output temperature” bright light, low/min heat. Also must be (UL) listed and similar to the (light-emitting diodes—LED) low temperature lights or light sources that are known in the field or industry.

Connections must be made from one section to another throughout the blanket(s) in order to create visual effects that will illuminate. The components and or elements can be shuffled Around and or interchanged/reconfigured in order to create this invention of visual effects that Illuminate. Example: The Zipper, battery holding compartment, energy storage conductors, control wires, light-source pattern(s), on & off switch, electrical/electronic elements, parts, and any type of components and devices that will be needed to complete this will and can be placed or Reconfigured in different positions and locations on the blanket(s)/bed covers/baby blankets day covers, bean bags, day blankets, and infant covers or any type of blanket like material(s).

The material or fabric that the (lights) light-illuminations and or light sources display on does not have to be a “blanket”. The light-illuminations/light sources may also be on a strip or section(s) of a strip(s) that can or may be prefabricated onto a piece or section of a material or template that already has the light sources or elements on or in them in order to be sown or Installed (attached) in or onto the finished product(s) or section of finished product(s) to create Or complete this invention/patent/license.

Any type of material that may be in existence or that may be invented and patented In the future in regards to a “light source” or light illumination or illuminations that can or may Produce this type of “effect(s)” may be used and installed in our product(s) to create visual light images that can or may display our design(s) and or pattern(s).

The light-illuminations will also have a section or design above the light-source(s) that Will be “magnified” or “projected” this will allow you (the consumer) to view clearly the image Or design/pattern above the blanket(s) and also the image/design/patterns above (at ceiling) Location(s).

The light sources will be enhanced from the blanket location with a small plastic like Magnifying lens or something similar to this and also not limited to a magnifying lens. The light Sources will be projected from the blanket location to the ceiling location above the bed where The blanket(s) are (installed flat) spread out, and not covering the light sources in order to create the visual effects, same pattern/design from blanket to ceiling at not more than 15′ feet, But not limited to this.

The material (light design/pattern with light sources on or in them) will be fixed in place. The light-illuminations/lights sources that you see on the blanket will be the same design/pattern that will be transferred up above onto the ceiling(s).

Any type of light source(s) that are not rated at 110 Volts AC, or more may be used for This Installation but is not limited to this. The light sources used are (Preferably) light-emitting Diodes (LED). The wattages (watts) of the light sources will be of many different varieties. Many Different designs and patterns will be created along with many different colors to create the Visual effects on the blanket(s) and also on or onto the ceiling(s). The voltage will also vary due to the size of the design and or light pattern(s).

### DESCRIPTION OF COMPONENTS/DEVICES/AND PARTS

On page 15 of 15 there is a drawing showing the “final” invention.

Item (B) on drawing are the “Voltage Cable Conductors” wires providing the proper current From the energy storage device to the light patterns/designs.

Item (L1) Light sources on the drawing are the “flowers, patterns/designs” that are going to Light up (illuminate) and are also going to display the same pattern onto the ceiling.

Item (B1) this is the “energy storage device” this is the battery that is going to store the “DC” Current in order to light up the (illuminate) designs/patterns.

Item (B2) this is the “pouch” kangaroo like holding container. This is where the energy storage Device is going to be installed & connected to the blankets internal power connecting Cable(s).

Item (Z) Zipper like compartment. This keeps the energy storage device from falling out.

Item (B1L) this is the part of the device that “plugs” into a standard 110 Volt (AC) wall socket. A basic sketch of this is shown below with the two indicator lights. This will allow The end user to know if the device is ready for use! Or, if it has to be “recharged”.

Item (SW) this is the On & Off switch or button. It will be located on the rechargeable energy Storage device. It may comprise of a “All-in-one device” (Control) that has two Electric male (plugs) ends that can bend up or down, “In or out” when not in use. The (SW) switch may also comprise into this “All-in-one” component, part.

(DC) stands for, Direct current. This DC voltage is going to vary depending on the design And pattern(s) that will be used and the amount of light sources needed.

(AC) stands for Alternating current. Average house convenient duplex receptacle is 110 Volts.

What is claimed is:

1. Light source patterns that illuminate from custom made blankets onto the bedroom ceilings for Infants, children's and teenagers rooms. These will be (preferably) light-emitting diodes (LED) displays with different colored illuminations from the blankets to the ceilings above the bed where the blankets are spread out. This will be working as a comfort light and is powered by a energy storage device, or a rechargeable energy storage device that stores (DC) direct current, and also may store different voltages and is plugged/connected to the blankets in order to create visual light source effects (visual illuminations) that can be seen from both the blanket(s) and the ceiling(s).
This Utility patent/Utility patent license for this invention mentioned above and in these documents, numbered Page 1 of 15, 2 of 15, 3 of 15, 4 of 15, 5 of 15, 6 of 15, 7 of 15, 8 of 15, 9 of 15, 10 of 15, 11 of 15, 12 of 15, 13 of 15, 14 of 15, 15 of 15 are claimed and created by one person. This (page) document is to prove (record) that this is not only created but also Invented, and is 100% owned and is also claimed and documented by Monica Aranda of 10083 Vena Ave. Arleta, Calif. 91331 as having an being 100% owner. I Monica Aranda also claim as being the Only owner of this license and invention. Monica Aranda also has 100%
ownership/possession/proprietorship/control/title/and all rights and is in 100% custody and control of this utility license/patent and invention for the term as per the USPTO & Government for the term of twenty years (20 years) according to the Laws and rules of the USPTO & The laws of the United States of America for this Unconditional Utility license.
Claimed is. Claimed as Having 100% Ownership, Possession, Proprietorship, Control, Title, Rights and as having 100% Custody of this Invention as documented in these pages from pages 1 of 15-15 of 15 including the drawing page, page number 15 of 15 and also on this Claimed Page as signed below.
I, Monica Aranda Claim/Claimed this Utility Patent & License and invention as having 100% Ownership, Control & ALL rights on this day as Documented and Notarized. Also with two Witnesses as seen below on this page 13 of 15.
